(19) United States
(12) Patent Application Publication
(10) Pub. No.: US 2021/0062540 A1
(43) Pub. Date: Mar. 4, 2021

(54) Switch Structure for Lock Deadbolt

(71) Applicant: Jeff Chen, Chiayi City (TW)

(72) Inventor: Jeff Chen, Chiayi City (TW)

(21) Appl. No.: 16/555,101

(22) Filed: Aug. 29, 2019

(51) Int. Cl. E05B 17/00; E05B 63/00; E05B 15/10

(52) U.S. Cl. CPC E05B 17/0041; E05B 15/10; E05B 63/0017

(57) ABSTRACT

A switch structure for a lock deadbolt contains: a body, a sliding device, a shifting element, and a flexible buffer. The body includes two bases having a fastener and a connection portion. The two bases have an actuation section, a slide space, a receiving room, two slots, two first orifices, four second orifices, and a positioning zone. The sliding device includes a slidable segment, an extending sheet, a groove, and two wings. The slidable segment has a coupling portion. The shifting element includes a rotary shaft, a cross-shaped trench, a swing column, a rotatable seat, two abutting faces, and a connecting area of the two abutting faces is a contacting edge. The flexible buffer is located on the positioning zone of the two bases, and the flexible buffer includes a cushion portion, two flexible holders, two flexible chambers, and two support feet.

### BACKGROUND OF THE INVENTION

### Field of the Invention

The present invention relates to a switch structure for a lock deadbolt which enhances a flexible returning of a shifting element by ways of a flexible buffer.

### Description of the Prior Art

A conventional lock contains components which are not changeable and applicable for doors of various specifications.

A conventional lock deadbolt contains a body, an extension extending from a first end of the body, and a pull plate extending from a second end of the body, wherein the pull plate actuates the extension. The pull plate has two support sheets mounted on a front side and a rear side thereof respectively, and a drive piece defined between the two support sheets and having a C-shaped cross section. The drive piece having a C-shaped cross section actuates a rotatable button, and the two support sheets have two circularly elongated orifices defined thereon respectively so that the rotatable button is inserted through the two circularly elongated orifices. However, when the conventional lock deadbolt is switched, it is easy to cause a friction loss because of unlocking/locking the lock deadbolt, thus switching the lock dead bolt forcefully.

The present invention has arisen to mitigate and/or obviate the afore-described disadvantages.

### SUMMARY OF THE INVENTION

The primary objective of the present invention is to provide a switch structure for a lock deadbolt which contains a body, a sliding device, a shifting element, and a flexible buffer.

Thereby, the shifting element is rotated to actuate the sliding device, and the deadbolt head is urged by the sliding device to extend and retract in the body, then the shifting element is rotated so that the two abutting faces and the contacting edge force the flexible buffer. The contacting edge forces the flexible buffer downward so as to produce a flexible buffer and a balanced reduced pressure, thus rotating the shifting element easily and enhancing flexible returning of the flexible buffer.

### BRIEF DESCRIPTION OF THE DRAWINGS

FIG. 1 is a perspective view showing the assembly of a switch structure for a lock deadbolt according to a preferred embodiment of the present invention.

FIG. 2 is another perspective view showing the assembly of the switch structure for the lock deadbolt according to the preferred embodiment of the present invention.

FIG. 3 is a perspective view showing the exploded components of the switch structure for the lock deadbolt according to the preferred embodiment of the present invention.

FIG. 4 is a perspective view showing the assembly of a shifting element of the switch structure for the lock deadbolt according to the preferred embodiment of the present invention.

FIG. 5 is a perspective view showing the assembly of a flexible buffer of the switch structure for the lock deadbolt according to the preferred embodiment of the present invention.

FIG. 6 is a cross-sectional perspective view showing the operation of the shifting element of the switch structure for the lock deadbolt according to the preferred embodiment of the present invention.

FIG. 7 is another cross-sectional perspective view showing the operation of the shifting element of the switch structure for the lock deadbolt according to the preferred embodiment of the present invention.

FIG. 8 is also another cross-sectional perspective view showing the operation of the shifting element of the switch structure for the lock deadbolt according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

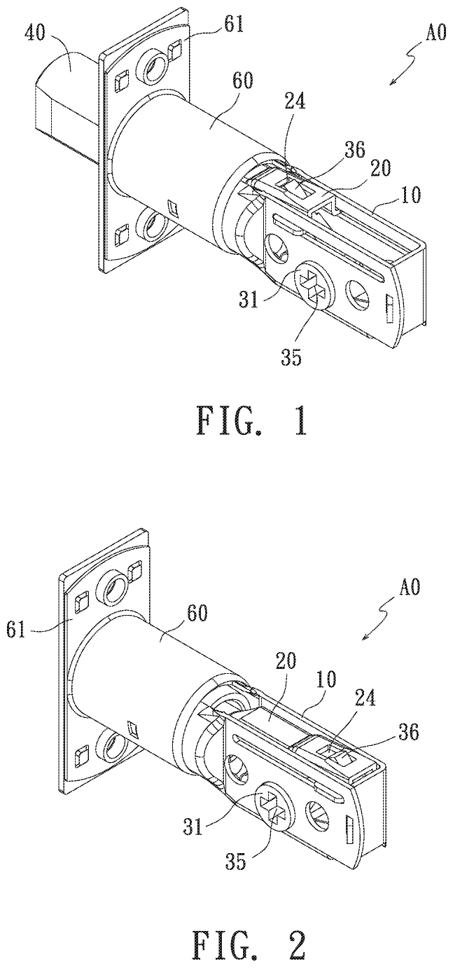

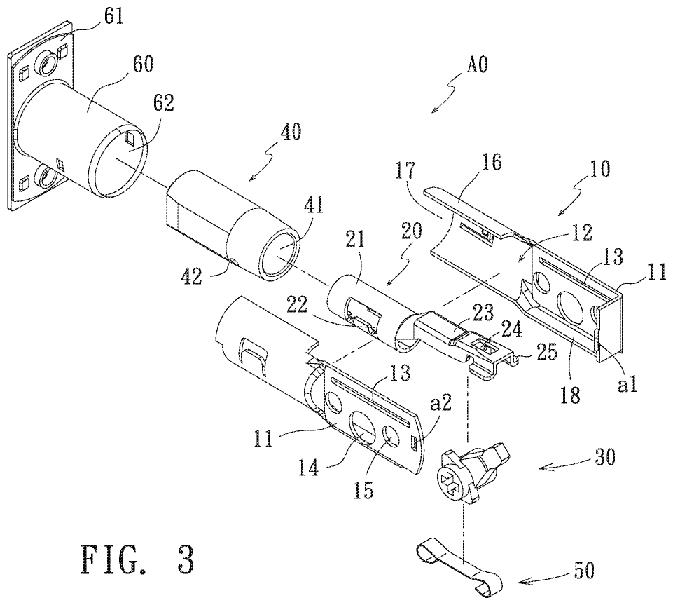

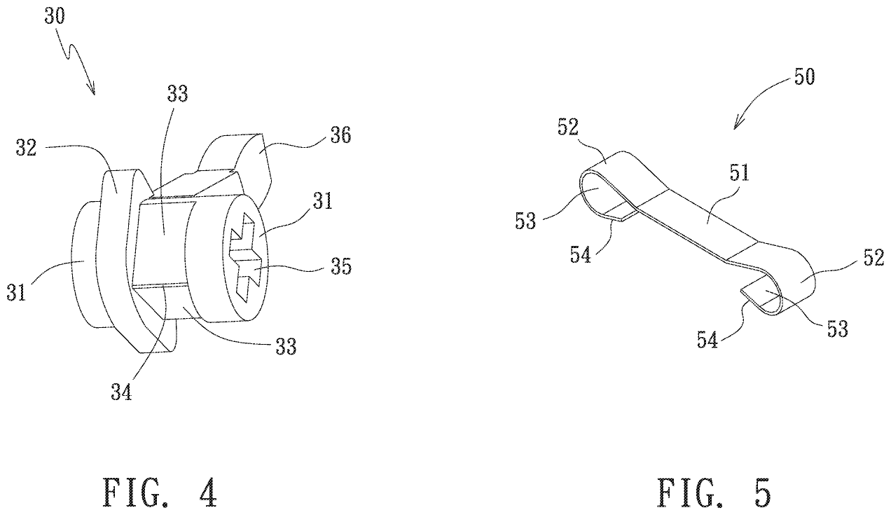

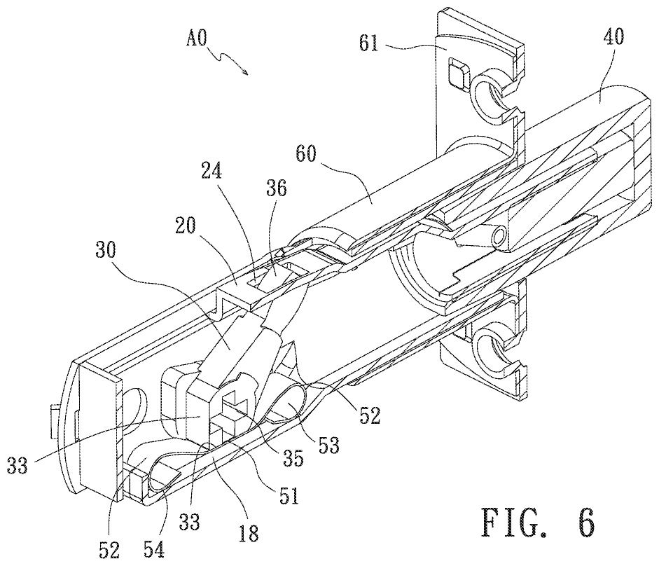

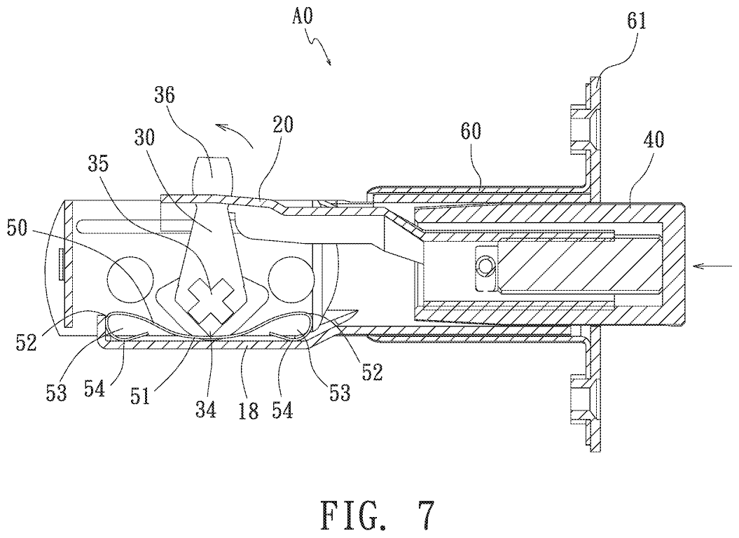

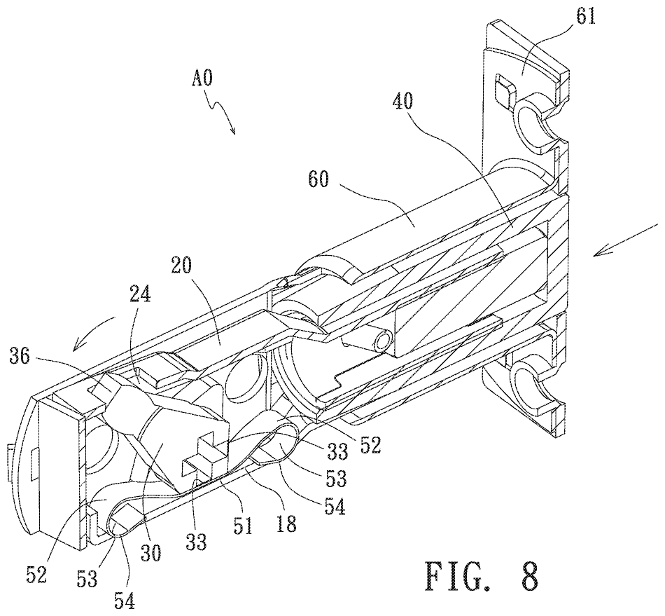

With reference to FIGS. 1-8, a switch structure 40 for a lock deadbolt according to a preferred embodiment of the present invention comprises:

a body 10 including two bases 11 having a fastener a1 and a connection portion a2 so that the two bases 11 are connected to form the body 10 by ways of the fastener a1 and the connection portion a2, wherein the two bases 11 have an actuation section 16 formed on two first ends of the two bases 11, a slide space 17 defined inside the two bases 11, a receiving room 12 formed inside the two bases 11, two slots 13 defined on two sides of the two bases 11 respectively and communicating with the receiving room 12, two first orifices 14 formed below the two slots 13 individually, four second orifices 15 defined beside the two first orifices 14 respectively, and a positioning zone 18 formed in the receiving room 12 of the two bases 11 corresponding to the two slots 13 respectively;

a sliding device 20 including a slidable segment 21 extending on a first end of the sliding device 20 and accommodated in the slide space 17 of the body 10, an extending sheet 23 extending on a second end of the slidable segment 21, a groove 24 longitudinally formed on a distal end of the extending sheet 23, and two wings 25 extending from two sides of the groove 24 and slidably connected with the two slots 13 individually, wherein the slidable segment 21 has a coupling portion 22 arranged on a predetermined position of a front end thereof;

a shifting element 30 including a rotary shaft 31 rotatably connected with the two first orifices 14 of the body 10, a cross-shaped trench 35 passing through the rotary shaft 31, a swing column 36 radially extending from a predetermined position of the rotary shaft 31, wherein the swing column 38 is rotatably inserted into the groove 24 of the sliding device 20, the sliding device 20 further includes a rotatable seat 32 extending from a side of the rotary shaft 31, two abutting faces 33 formed on two bottoms of the swing 36 respectively in a V shape, and a connecting area of the two abutting faces 33 is a contacting edge 34;

a flexible buffer 50 located on the positioning zone 18 of the two bases 11, and the flexible buffer 50 including a cushion portion 51 formed on a central section of the flexible buffer 50, two flexible holders 52 arranged on two ends of the cushion portion 51 individually, two flexible chambers 53 defined inside the two flexible holders 52 respectively, and two support feet 54 extending on two bottoms of two ends of the flexible buffer 50 individually, wherein the cushion portion 51, the two flexible holders 52, and the two support feet 54 of the flexible buffer 50 are integrally made of flexible metal; the two flexible holders 52 of the flexible buffer 50 have two arcuate cross sections individually; the cushion portion 51 is aligned with the two abutting faces 33 and the contacting edge 34 of the swing column 36 of the shifting element 30, such that when the shifting element 30 is rotated, the two abutting faces 33 and the contacting edge 34 of the shifting element 30 force the cushion portion 51 of the flexible buffer 50; and

a deadbolt head 40 including a fixing portion 41 formed on a first end of the deadbolt head 40 and fitted with the slidable segment 21 of the sliding device 20, a driven portion 42 corresponding to the coupling portion 22 of the sliding device 20 so that when the fixing portion 41 is fitted with the slidable segment 21 of the sliding device 20, the driven portion 42 is fixed with the coupling portion 22 of the sliding device 20, a second end of the deadbolt head 40 is inserted into a through hole 62 of a first end of a stopper 60, and the stopper 60 includes a limitation piece 61 arranged on a second end thereof.

The shifting element 30 is rotated to actuate the sliding device 20, and the deadbolt head 40 is urged by the sliding device 20 to extend and retract in the body 10, then the shifting element 30 is rotated so that the two abutting faces 33 and the contacting edge 34 force the flexible buffer 50, wherein the contacting edge 34 forces the flexible buffer 50 downward so as to produce a flexible buffer and a balanced reduced pressure, thus rotating the shifting element 30 easily and enhancing flexible returning of the flexible buffer 50.

While various embodiments in accordance with the present invention have been shown and described, it is clear to those skilled in the art that further embodiments may be made without departing from the scope of the present invention.

What is claimed is:

1. A switch structure for a lock deadbolt comprising:
a body including two bases having a fastener and a connection portion so that the two bases are connected to form the body by ways of the fastener and the connection portion, wherein the two bases have an actuation section formed on two first ends of the two bases, a slide space defined inside the two bases, a receiving room formed inside the two bases, two slots defined on two sides of a second end of the two bases respectively and communicating with the receiving room, two first orifices formed below the two slots individually, four second orifices defined beside the two first orifices respectively, and a positioning zone formed in the receiving room of the two bases corresponding to the two slots respectively;
a sliding device including a slidable segment extending on a first end of the sliding device and accommodated in the slide space of the body, an extending sheet extending on a second end of the sliding device, a groove longitudinally formed on a distal end of the extending sheet, and two wings extending from two sides of the groove and slidably connected with the two slots individually, wherein the slidable segment has a coupling portion arranged on a predetermined position of a front end thereof;
a shifting element including a rotary shaft rotatably connected with the two first orifices of the body, a cross-shaped trench passing through the rotary shaft, a swing column radially extending from a predetermined position of the rotary shaft, wherein the swing column is rotatably inserted into the groove of the sliding device, the sliding device further includes a rotatable seat extending from a side of the rotary shaft, two abutting faces formed on two bottoms of the swing respectively in a V shape, and a connecting area of the two abutting faces is a contacting edge;
wherein a flexible buffer is located on the positioning zone of the two bases, and the flexible buffer includes a cushion portion formed on a central section of the flexible buffer, two flexible holders arranged on two ends of the cushion portion individually, two flexible chambers defined inside the two flexible holders respectively, and two support feet extending on two bottoms of two ends of the flexible buffer individually, wherein the cushion portion is aligned with the two abutting faces and the contacting edge of the swing column of the shifting element, such that when the shifting element is rotated, the two abutting faces and the contacting edge of the shifting element force the cushion portion of the flexible buffer.

2. The switch structure as claimed in claim 1, wherein a deadbolt head is fitted with the slidable segment of the sliding device and includes a fixing portion formed on a first end of the deadbolt head, a driven portion corresponding to the coupling portion of the sliding device so that when the fixing portion is fitted with the slidable segment of the sliding device, the driven portion is fixed with the coupling portion of the sliding device.

3. The switch structure as claimed in claim 2, wherein a second end of the deadbolt head is inserted into a through hole of a first end of a stopper, and the stopper includes a limitation piece arranged on a second end thereof.

4. The switch structure as claimed in claim 1, wherein the cushion portion, the two flexible holders, and the two support feet of the flexible buffer are integrally made of flexible metal.

5. The switch structure as claimed in claim 1, wherein the two flexible holders of the flexible buffer have two arcuate cross sections individually.
